(19) United States
(12) Patent Application Publication
(10) Pub. No.: US 2026/0296422 A1
(43) Pub. Date: Oct. 1, 2026

(54) Vehicle and Method for Operating a Vehicle

(71) Applicant: Robert Bosch GmbH, Stuttgart (DE)

(72) Inventors: Christian Riese, Stuttgart (DE); Thomas Kurz, Roemerberg (DE); Matthias Ehrmann, Neuhausen (DE); Tobias Ritz, Leonberg (DE)

(21) Appl. No.: 19/480,814

(22) PCT Filed: May 2, 2024
(86) PCT No.: PCT/EP2024/062045

§ 371 Date: Nov. 2, 2025

(30) Foreign Application Priority Data
May 5, 2023 (DE) 10 2023 204 190.1

(51) Int. Cl. B60W 30/14; B60W 10/18; B60W 10/20

(52) U.S. Cl. CPC B60W 30/143; B60W 10/18; B60W 10/20; B60W 2540/18; B60W 2552/05; B60W 2710/18

(57) ABSTRACT

A vehicle, in particular a motor vehicle, is disclosed including at least one steerable vehicle axle, which provides an increased wheel steering angle setting range, in particular with a maximum wheel steering angle of more than 40°, including a steering system that is operatively connected to the steerable vehicle axle for providing steering functionality, including a braking system for providing a braking functionality, and including an electrical and/or electronic brake function unit. The brake function unit has at least one brake control function which is intended to at least partially restrict the braking functionality during a steering operation in which a vehicle speed of the vehicle is below a limit speed. The brake function unit has at least one activation function which is intended to activate the brake control function only when a wheel steering angle limit is exceeded.

### PRIOR ART

The invention relates to a vehicle according to claim 1 and a method for operating a vehicle according to claim 8.

Prior art discloses vehicles that comprise a steerable vehicle axle, a steering system for steering the vehicle, and a braking system for braking the vehicle. Electrically assisted steering systems with electric motors as a source of propulsion must be designed so that any driving maneuvers occurring during operation of the vehicle can be carried out. For driving maneuvers that occur during normal vehicle operation, relatively low steering torques are required from the steering system and in particular from the electric motor in order to achieve turning of the vehicle wheels. In contrast, very high steering torques are required especially when steering in the low-speed range or while the vehicle is stationary, so that these driving maneuvers characterize a main design point of the steering system. Steering while the vehicle is stationary can further occur without actuation of the braking system or with actuation of the braking system, wherein in the event that braking torque affects the steerable vehicle axle, the steering torque to be applied for steering the vehicle wheels is once again higher. Reference in this context is made to DE 10 2018 211 897A1, as an example.

Furthermore, vehicles with an increased wheel steering angle setting range are known, in which a maximum achievable wheel steering angle is above 40°, for example between −90° and +90°. Such vehicles are typically equipped with steer-by-wire steering systems. In particular, single-wheel controllers permit high wheel steering angles to be easily implemented, because the vehicle wheels are decoupled from one another, making compliance with kinematic requirements easier than for central controllers. Reference in this context is made to DE 10 2015 220 775A1, as an example.

Especially for vehicles with an increased wheel steering angle setting range, the requirements for a steering torque to be set for steering the vehicle wheels are significantly increased again. In this case, the required steering torque can increase considerably again from a wheel steering angle of approximately ±20° and in particular from a wheel steering angle of approximately ±40°.

The object of the invention is therefore in particular to provide a vehicle and a method for operating a vehicle with an increased wheel steering angle setting range, which comprises improved properties with respect to an efficiency. The problem is solved by the features of claims 1 and 8, while advantageous embodiments and further embodiments of the invention can be taken from the dependent claims.

### DISCLOSURE OF THE INVENTION

The invention relates to a vehicle comprising at least one steerable vehicle axle, which provides an increased wheel steering angle setting range, in particular with a maximum wheel steering angle of more than 40°, comprising a steering system that is operatively connected to the steerable vehicle axle for providing steering functionality, comprising a braking system for providing a braking functionality, and comprising an electrical and/or electronic brake function unit, wherein the brake function unit has at least one brake control function, which is intended to at least partially restrict the braking functionality during a steering operation in which a vehicle speed of the vehicle is below a limit speed, and wherein the brake function unit has at least one activation function which is intended to activate the brake control function only when an advantageously pre-applied wheel steering angle limit is exceeded. In particular, the braking functionality is thus only restricted when the wheel steering angle limit is exceeded. Furthermore, during the steering operation, the braking system may also be actuated, in particular in the form of manual braking engagement and/or automatic braking engagement. In the present case, the wheel steering angle limit may be at least 20°. Preferably, however, the wheel steering angle limit is at least 40°. This configuration can particularly improve efficiency, for example performance efficiency, energy efficiency, building space efficiency, weight efficiency and/or cost efficiency. In particular, the steering system or a steering actuator of the steering system may be smaller in size, which advantageously results in a reduction in the space requirement and/or a reduction in the weight of the steering system. Preferably, the restriction of the braking functionality does not take place in the normal steering angle range, but rather only becomes active at higher wheel steering angles in order to be able to achieve this at optimal strength with correspondingly small-sized steering actuators. Moreover, advantageously, tire wear may be reduced while minimizing wear appearance, which may improve the useful life and/or fatigue strength. Furthermore, the energy demand of the steering system may also be reduced.

The vehicle is in particular configured as a motor vehicle and advantageously as a passenger vehicle or as a commercial vehicle. Furthermore, the steerable vehicle axle is advantageously configured as a front axle of the vehicle. In addition, the vehicle may comprise at least one, advantageously rigid and/or non-steerable, further vehicle axis, at least a first sensor unit for detecting steering movement and/or steering information, at least a second sensor unit for detecting a vehicle speed of the vehicle, and/or at least a third sensor unit for detecting actuation of the braking system. In the present case, the steering system is intended to provide a steering torque for steering the vehicle and to transmit it to the steerable vehicle axle. To this end, the steering system comprises at least one steering actuator, for example in the form of an electric motor. Moreover, the steering system can particularly be designed as a conventional steering system with a mechanical hand grip, for example as a power steering system. Preferably, however, the steering system is configured as a steer-by-wire steering system and is thus free of a direct mechanical connection between a steering handle and the steerable vehicle axle. In this context, the steering system can in particular comprise at least one wheel steering angle controller configured as a central controller, in particular with at least one steering actuator, or preferably a plurality of wheel steering angle controllers configured as single-wheel controllers, in particular each with at least one steering actuator. Furthermore, a “wheel steering angle setting range” shall in particular be understood to mean a maximum range within which a deflection and/or movement of the steering system, and consequently a change of the wheel steering angle of the respective vehicle wheel, is possible. A maximum wheel steering angle setting range thus corresponds in particular to a maximum range of motion of the vehicle wheel, which is advantageously defined by fixed mechanical limitations of the vehicle. In addition, an “increased wheel steering angle setting range” is to be understood in particular as a range that is greater than a conventional wheel steering angle setting range and accordingly has in particular a maximum wheel steering angle of more than approximately 40°. Preferably, the increased wheel steering angle setting range may provide, for example, a wheel steering angle of between −60° and +60°, or more preferably between −90° and +90°.

Moreover, the braking system is operatively connected to at least the steerable vehicle axle and/or the further vehicle axle and is intended to provide braking torque for braking the vehicle. The braking system is in particular intended to apply the braking torque to at least one of the vehicle axes during actuation, for example by a driver, and during a braking operation caused thereby. To this end, the braking system comprises at least one operating brake, for example configured as a disc brake and/or a drum brake, and/or at least one parking brake, in particular a mechanically and/or electrically configured, parking brake. Furthermore, a “brake function unit” is to be understood in particular as a unit that is operatively connected to the steering system, to the braking system, and/or to the sensor units, and that is intended to determine a vehicle speed of the vehicle, a steering operation caused by the steering system, and/or an actuation of the braking system and, as a result, to at least partially restrict the braking functionality, in particular the braking system. To this end, the brake function unit includes at least one brake control function, preferably in the form of a corresponding brake control algorithm. In the present case, the brake function unit also includes at least one activation function, which is operatively connected to the brake control function, preferably in the form of a corresponding activation algorithm, which is intended to monitor a wheel steering angle of the vehicle wheels and, when the wheel steering angle limit is exceeded, to control the brake control function and to activate it to initiate and/or cause a restriction of the braking functionality. Preferably, the brake control unit is in this case further integrated into a control device of the vehicle, e.g., a central vehicle control device, or a control device of the steering system, in particular a steering control device. In the following sections, the fact that the brake function unit or brake control function is intended to “at least partially restrict the brake functionality” is to be understood in particular as the brake function unit or brake control function being intended to control the braking system in such a way that at least one braking function associated with the braking functionality of the braking system is restricted, advantageously such that that the braking function is only available to a limited extent or is not performed and/or is not executable. The term “provided” is understood in particular as meaning specifically programmed, designed and/or equipped. In particular, the phrase “an object being provided for a specific function” is intended to mean that the object fulfills and/or performs this specific function in at least one application state and/or operating state.

Furthermore, it is suggested that the brake function unit comprises at least one deactivation function, preferably in the form of a corresponding deactivation algorithm, which is intended to deactivate the brake control function upon falling below the wheel steering angle limit and/or to cancel a restriction of the braking functionality. In particular, the activation function and the deactivation function may also be realized within the same function. This may advantageously ensure that the brake control function is activated only at wheel steering angles above the wheel steering angle limit and is otherwise deactivated.

Furthermore, it is proposed that the braking system includes a plurality of individually actuatable wheel brakes, for example, in the form of decentralized electromechanical operating brakes, and the brake function unit, in particular the brake control function, is intended to restrict the braking functionality during the steering operation such that braking torque acting on the steerable vehicle axis is reduced. In this context, for example, a braking torque on both steerable vehicle wheels could be reduced, or there could be only a braking torque on an outer vehicle wheel. However, it is preferably suggested that at least one braking torque is reduced on an inner vehicle wheel, and in particular exclusively on the inner vehicle wheel. In this case, the brake function unit, in particular the brake control function, is intended to restrict the braking functionality during the steering operation such that braking torque acting on the steerable vehicle axis is at least reduced. In particular, braking torque can be reduced to the steerable vehicle axle and an advantageous braking effect can be achieved at the same time.

If the vehicle comprises at least one further vehicle axis, in particular the already mentioned further vehicle axis, wherein the braking system is intended to apply braking of the vehicle to the further vehicle axis during the steering operation only, braking of the vehicle can be achieved in particular in operating states, in which braking is absolutely necessary, such as when sitting on a slope, without transferring braking torque to the steerable vehicle axle. In this case, the brake function unit, in particular the brake control function, is intended to restrict the braking functionality during the steering operation such that braking of the steerable vehicle axle is prevented by means of the braking system.

According to a further embodiment, it is proposed that the vehicle comprises vehicle sensors for detecting a vehicle incline and/or a roadway incline, for example in the form of inertial sensors, wherein the brake function unit, in particular the brake control function, is intended to account for the vehicle incline and/or the roadway incline when restricting brake functionality. It is also particularly preferred for the brake function unit, in particular the brake control function, to be intended to vary the braking torques on the individual vehicle wheels on an individual wheel basis depending on the vehicle incline and/or the roadway incline, in particular such that each vehicle wheel is braked so strongly that the vehicle does not move. In addition, in this case, the type of vehicle can also be considered. In this context, for example, depending on the type of vehicle and incline or descent, the braking torques are ideally adjusted on an individual wheel basis, in particular such that each vehicle wheel is braked so strongly that the vehicle does not move. This allows a particularly high efficiency to be achieved.

Furthermore, it is proposed that the vehicle include environmental sensors for sensing a vehicle environment, wherein the brake function unit, particularly the brake control function, is intended to account for environmental objects in the vehicle environment, such as other vehicles, people, and/or obstacles, when restricting braking functionality and varying braking torques on the individual vehicle wheels as a function of the environmental objects. For example, in this context, the braking torques may be varied to allow for low vehicle movement. Alternatively or additionally, the braking torques may be increased, for example, to avoid unwanted rolling and thus contact with objects in the vehicle environment. This can in particular further increase operational reliability.

In addition, a method for operating a vehicle, in particular of the aforementioned vehicle, is proposed, wherein the vehicle comprises at least one steerable vehicle axle with an increased wheel steering angle setting range, in particular with a maximum wheel steering angle of more than 40°, a steering system that is operatively connected to the steerable vehicle axle for providing steering functionality and a braking system for providing a braking functionality, wherein the braking functionality is at least partially restricted during a steering operation in which a vehicle speed of the vehicle is below a limit speed by means of a brake control function, and wherein the brake control function is only activated when a wheel steering angle limit is exceeded, in particular by means of the brake function unit's activation function. Thus in particular the aforementioned advantages can be achieved. This can particularly improve at least one efficiency, for example performance efficiency, energy efficiency, building space efficiency, weight efficiency and/or cost efficiency.

The vehicle and the method for operating the vehicle are not intended to be limited to the application and embodiment described hereinabove. In particular, the vehicle and the method for operating the vehicle in order to achieve the functioning described herein can comprise a number of individual elements, components, and units that differ from the number specified herein.

### DRAWINGS

Further advantages follow from the description of the drawings below. The drawings show an exemplary embodiment of the invention.

The figures show:

FIG. 1 shows an exemplary vehicle configured as a passenger vehicle with a steerable vehicle axle, a steering system, and a braking system in a schematic representation,

FIG. 2 shows the steering system in a detailed illustration; and

FIG. 3 shows an exemplary flow chart with the main method steps of a method for operating the vehicle.

### DESCRIPTION OF THE EXEMPLARY EMBODIMENT

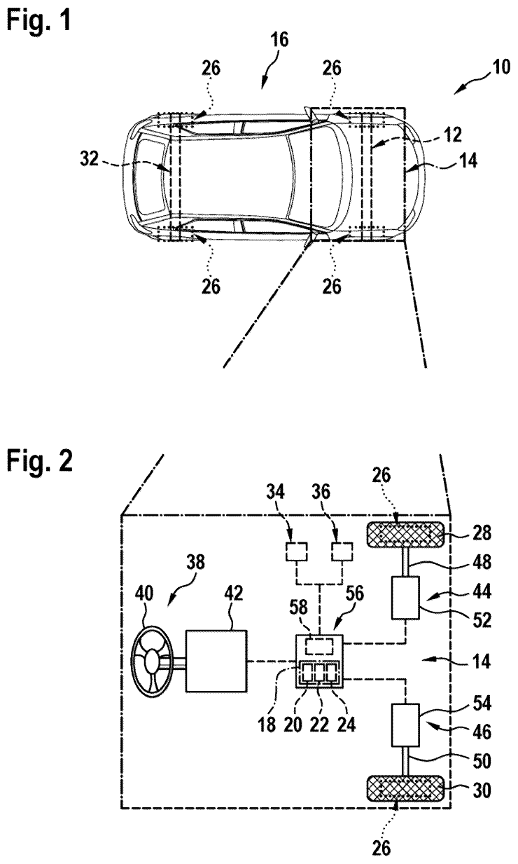

FIG. 1 shows a simplified schematic illustration of a vehicle 10 which is, e.g., designed as a passenger vehicle comprising a plurality of vehicle wheels 28, 30. The vehicle 10 has multiple axles and, in the present case, has a first vehicle axle 12 and a second vehicle axle 32. The first vehicle axle 12 is configured as a front axle of the vehicle 10 and has a connection to front vehicle wheels 28, 30. The first vehicle axle 12 is steerable. Further, in the present case, the first vehicle axle 12 provides an increased wheel steering angle setting range with a maximum wheel steering angle of more than 40°. The second vehicle axle 32 is configured as a rear axle of the vehicle 10 and has a connection to rear vehicle wheels (not shown). The second vehicle axis 32 is further configured as a rigid vehicle axle and/or a non-steerable vehicle axle. Alternatively, however, a vehicle could also be configured as a commercial vehicle. Furthermore, a vehicle axle configured as a rear axle could be steerable while a vehicle axle configured as a front axle could be rigid and/or non-steerable. It is also generally conceivable to configure a vehicle axle designed as the front axle and a vehicle axle designed as the rear axle to both be steerable. Furthermore, a vehicle could also be configured as a three-axle vehicle with at least three vehicle axles or as a four-axle vehicle with at least four vehicle axles, wherein in particular at least one of the vehicle axles is steerable.

The vehicle 10 also comprises a steering system 14 (see in particular also FIG. 2). The steering system 14 is associated with the first vehicle axle 12, and consequently has an operative connection with the vehicle wheels 28, 30 configured as front wheels. The steering system 14 is intended to provide steering functionality for steering the vehicle 10 and/or for influencing a direction of travel of the vehicle 10. Furthermore, the steering system 14 is designed as a steer-by-wire steering system in the present case, in which a steering specification is transmitted electrically to the vehicle wheels 28, 30 in at least one operating state. However, in principle, it is also conceivable to associate a steering system with a second vehicle axle. Furthermore, it is conceivable to configure a steering system with a conventional power steering system.

The steering system 14 comprises a per se known operating unit 38. The operating unit 38 comprises a steering handle 40, for example in the form of a steering wheel, and a feedback actuator 42, which is in particular mechanically coupled to the steering handle 40 to create steering resistance and/or self-aligning torque on the steering handle 40. A steering handle could alternatively also be designed as a joystick, a steering lever, and/or as a steering ball or the like. A feedback actuator could in principle also be omitted. It is also conceivable to dispense with an operating unit altogether.

The steering system 14 further comprises at least one wheel steering angle controller 44, 46. As an example, the steering system 14 in the present case comprises two wheel steering angle controllers 44, 46 configured as a single wheel controller and consequently in particular allows individual wheel steering. The wheel steering angle controllers 44, 46 are associated with the first vehicle axle 12. The wheel steering angle controllers 44, 46 are designed separately from one another and in the present case are not mechanically connected. The wheel steering angle controllers 44, 46 can be controlled independently of one another. The wheel steering angle controllers 44, 46 can be configured as translational or rotary single wheel controllers. The wheel steering angle controllers 44, 46 are moreover connected to the operating unit 38, and consequently the steering handle 40, in a purely electrical manner. Each of the wheel steering angle controllers 44, 46 has an operative connection to exactly one of the vehicle wheels 28, 30, in particular a front wheel. The wheel steering angle controllers 44, 46 are intended to change a respective wheel steering angle of the respective vehicle wheel 28, 30, in the present case, in a wheel steering angle range of between −90° and +90°, for example. For this purpose, each of the wheel steering angle controllers 44, 46 comprises a steering actuator element 48, 50, e.g. configured as a gear rack, and a steering actuator 52, 54 cooperating with the steering actuator element 48, 50 and configured as an electric motor. Of course, a steering system could in principle also comprise a wheel steering angle controller configured as a central controller. A steering system can furthermore also comprise at least four wheel steering angle controllers configured as single-wheel controllers, wherein a wheel steering angle controller is assigned to each vehicle wheel. A steering system could in principle also comprise a combination of a wheel steering angle controller configured as a single-wheel controller and a wheel steering angle controller configured as a central controller. Moreover, at least one wheel steering angle controller could also be assigned to a vehicle wheel that is configured as a rear wheel.

Moreover, the vehicle 10 includes a braking system 16. The braking system 16 is associated with the first vehicle axle 12 and the second vehicle axle 32, and consequently is operatively connected to vehicle wheels 28, 30 configured as front wheels and rear wheels. The braking system 16 is intended to provide a braking functionality for braking the vehicle 10. In the present case, the braking system 16 is intended to transfer braking torque to the first vehicle axle 12 and/or the second vehicle axle 32 upon actuation, for example by a driver, and during a braking operation thereby caused. In principle, however, it is also conceivable to associate a braking system with a first vehicle axle or a second vehicle axle.

The braking system 16 comprises at least one wheel brake 26, in particular configured as an operating brake. In the present case, the braking system 16 includes, by way of example, four individually actuatable wheel brakes 26, wherein each vehicle wheel 28, 30 is associated with one of the wheel brakes 26. Two first wheel brakes 26 are consequently associated with vehicle wheels 28, 30 configured as front wheels and are intended to act on the first vehicle axle 12 to brake the vehicle 10. Two second wheel brakes 26 are associated with vehicle wheels configured as rear wheels and are intended to act on the second vehicle axle 32 to brake vehicle 10. Furthermore, the wheel brakes 26 are decentralized electromechanical wheel brakes, for example. Alternatively, a braking system could also have exactly two wheel brakes, wherein a first wheel brake may be associated with, for example, a first vehicle axle and a second wheel brake with a second vehicle axle. In particular, a central brake could also be arranged on a rear axle. Also, a braking system could be associated with only a first vehicle axle or a second vehicle axle. Furthermore, a braking system could include further brake units, for example in the form of a parking brake.

Furthermore, the vehicle 10 may comprise a plurality of sensor units. In the present case, for example, the vehicle 10 comprises a first sensor unit (not shown) for detecting steering information correlated to a steering movement, a second sensor unit (not shown) for detecting a vehicle speed, a third sensor unit (not shown) for detecting actuation of the braking system 16, a vehicle sensor 34 for detecting a vehicle incline and/or a roadway incline, and an environment sensor 36 for detecting a vehicle environment. In principle, however, it is also conceivable to dispense with a first sensor unit, a second sensor unit, a third sensor unit, vehicle sensors, and/or environmental sensors.

The vehicle 10 further comprises a control device 56. In the present case, the control device 56 is designed as a steering control device. In principle, however, a control device can also be configured as any control device of a vehicle deviating from a steering control device, for example as a brake control device or as a central vehicle control device. The control device 56 comprises an electrical connection to the steering system 14. The control device 56 also comprises an electrical connection to the braking system 16. In addition, the control device 56 has an electrical connection to the sensor units, in particular the first sensor unit, the second sensor unit, the third sensor unit, the vehicle sensors 34, and the environmental sensors 36. The control device 56 is intended to receive the steering information, vehicle speed, and actuation of the braking system 16 from the respective sensor units. Also, in the present case, the control device 56 is intended to receive the vehicle incline and/or roadway incline from vehicle sensors 34 and a detection signal correlated to the vehicle environment from environmental sensors 36. Furthermore, the control device 56 is provided at least for controlling the braking system 16, in particular based on the steering information, the vehicle speed, and/or the actuation of the braking system 16.

To this end, the control device 56 includes an electrical and/or electronic computing unit 58. The computing unit 58 comprises at least one processor (not depicted), e.g., in the form of a microprocessor, and at least one memory (not depicted). The computing unit 58 also comprises at least one operating program which is stored in the memory and includes at least one calculation routine, at least one control routine, and at least one braking routine.

The control device 56 further includes a brake function unit 18. The brake function unit 18 is communicatively connected to the computing unit 58. The brake function unit 18 also has an operative connection to the sensor units and is intended to receive and process steering information, vehicle speed, actuation of the braking system 16, vehicle incline and/or roadway incline, and the detection signal correlated to the vehicle environment. The brake function unit 18 is configured as a further electrical and/or electronic computing unit. The brake function unit 18 therefore comprises at least one processor (not shown), for example in the form of a microprocessor, and at least one further memory (not shown). In addition, in the present case, the brake function unit 18 includes a brake control function 20, an activation function 22, and a deactivation function 24. In principle, however, a control device could also only comprise a computing unit, wherein a brake function unit could be integrated into the single computing unit of the control device. Furthermore, a brake function unit could also be configured separately from a control device of the vehicle. In addition, it is conceivable to dispense with a deactivation function or to implement it into an activation function.

For driving maneuvers that occur during normal driving operation of the vehicle 10, i.e. at higher vehicle speeds, relatively low steering torques are required from the steering system 14, and in particular from the steering actuators 52, 54, to turn the vehicle wheels 28, 30. For this reason, the control device 56, and in particular the computing unit 58, is, during normal travel operation, in particular at a vehicle speed above a limit speed and independent of a steering movement, intended to control the braking system 16 such that when the braking system 16 is actuated, all of the wheel brakes 26 are actuated and consequently both the first vehicle axle 12 and the second vehicle axle 32 are or can be impacted with braking torque.

On the other hand, very high steering torques are required especially when steering in the low speed range or when the vehicle 10 is stationary. For this reason, the brake control function 20 is intended to limit braking functionality of the braking system 16 during a steering operation where a vehicle speed of vehicle 10 is below the limit speed. Simultaneously, in the present case, the activation function 22 is intended to monitor a wheel steering angle of the vehicle wheels 28, 30 and to activate the brake control function only when a wheel steering angle limit is exceeded. Thus, the braking functionality is only restricted when the wheel steering angle limit is exceeded, which, for example, can be 40°. This takes into account the fact that the requirements for a steering torque to be set for steering the vehicle wheels 28, 30, especially for vehicles 10 with an increased wheel steering angle setting range, are again significantly increased. In principle, however, a wheel steering angle limit could also be at least 20° or at least 30°. In this context, the steering angle range, in which the function according to the invention is active could be selected depending on the behavior of the axle and, for example, could already be activated from approximately 20° or from approximately 30°. In the present case, the restriction of the braking functionality is therefore not carried out in the normal steering angle range, but rather only becomes active at higher wheel steering angles in order to be able to achieve it with correspondingly small-sized steering actuators 52, 54.

In addition, the deactivation function 24 is intended to deactivate the brake control function 20 when the wheel steering angle is below the limit, and thereby cancel a restriction of the braking functionality again, thereby ensuring that the brake control function is only activated at wheel steering angles above the wheel steering angle limit and otherwise deactivated. Below the wheel steering angle limit, the normal braking of all vehicle wheels 28, 30 is thus free again.

Furthermore, brake function unit 18, and in particular the brake control function 20, is intended to restrict braking functionality during the steering operation such that braking torque acting on the steerable vehicle axle 12 is reduced, wherein in particular braking torque on an inner vehicle wheel 28, 30 is reduced, because larger steering torques are required here. Alternatively, however, braking torque on an outer vehicle wheel could also be reduced. In essence, the invention makes use of the possibility to situatively trigger the electronically individually controllable wheel brakes 26 in such a way that rolling of the vehicle 10 is excluded. At the same time, however, a high wheel steering angle with low steering torque is to be achieved.

Furthermore, braking torque on both steerable vehicle wheels 28, 30 could also be reduced. In this case, the braking system 16 is intended to impact the further vehicle axle 32 exclusively during the steering operation, in order to brake vehicle 10. Accordingly, the brake function unit 18, in particular the brake control function 20, is intended to restrict the braking functionality during the steering operation such that braking of the, in particular steerable, first vehicle axle 12 is prevented during the steering operation. As a result, in operating states in which braking is absolutely necessary, such as when sitting on a slope, braking of the vehicle 10 can be achieved without transferring braking torque to the first vehicle axle 12.

According to another aspect, the brake function unit 18, and in particular brake control function 20, may account for vehicle incline and/or roadway incline transmitted by vehicle sensors 34 when restricting braking functionality. In this context, the brake function unit 18, and in particular the brake control function 20, may be intended, for example, to vary the braking torques on the individual vehicle wheels 28, 30 on an individual wheel basis depending on the vehicle incline and/or the roadway incline, namely, such that each vehicle wheel 28, 30 is braked so strongly that the vehicle 10 does not move. In addition, in this case, the type of vehicle can also be considered. Depending on the type of vehicle and incline or descent, the braking torques can be ideally adjusted on an individual wheel basis. However, it is also generally conceivable to dispense with such consideration of a vehicle incline and/or a roadway incline.

Moreover, the brake function unit 18, and in particular the brake control function 20, may be intended to account for environmental objects in the vehicle environment transmitted by environmental sensors 36, such as other vehicles, people, and/or obstacles, in limiting braking functionality and varying braking torques on individual vehicle wheels as a function of the environmental objects. For example, in this context, the braking torques may be varied to allow for low vehicle movement. Alternatively or additionally, the braking torques may be increased, for example, to avoid unwanted rolling and thus contact with objects in the vehicle environment.

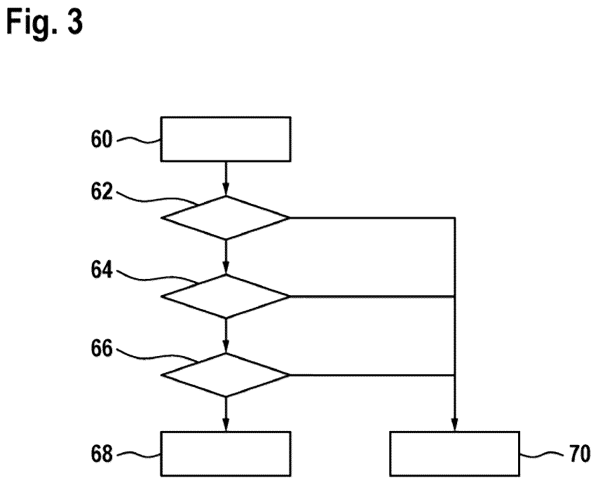

Finally, FIG. 3 shows an exemplary flow chart with the main method steps of a method for operating the vehicle 10.

In a method step 60, operation of the vehicle 10 starts.

In a method step 62, it is checked whether steering movement is performed, for example by a driver.

If steering movement is detected, a method step 64 checks whether a vehicle speed of the vehicle 10 is below the limit speed.

If the vehicle speed of the vehicle 10 is below the limit speed, then in a method step 66, a current wheel steering angle is determined using the activation function 22 and is compared to a wheel steering angle limit.

If the current wheel steering angle exceeds the wheel steering angle limit, then in a method step 68, the brake control function 20 is activated, in particular by means of the activation function 22, and the braking functionality is at least partially restricted by means of the brake control function 20.

If any of the conditions in method steps 62, 64, 66 are not satisfied, for example because no steering movement is detected, if the vehicle speed of vehicle 10 is above the limit speed and/or if the current wheel steering angle is below the wheel steering angle limit, the method is ended and restarted in a method step 70. In this case, the braking functionality of the braking system 16 is not restricted.

The exemplary flow chart in FIG. 3 is particularly only intended to describe an exemplary method for operating the vehicle 10. In particular, individual method steps and/or the order of the method steps can vary. In particular, it is conceivable to additionally detect an actuation of the braking system 16 and to restrict the braking functionality only if an actual actuation of the braking system 16 takes place. Furthermore, in particular, a central brake could also be arranged on a rear axle, thereby allowing steering torques to be reduced further, since a certain rotation of the vehicle 10 about the high axle is allowed. It is also conceivable to consider vehicle incline and/or roadway incline and/or environmental objects in the vehicle environment when restricting braking functionality.

1. A vehicle, comprising:
at least one steerable vehicle axle configured to provide an increased wheel steering angle setting range,
a steering system that is operatively connected to the steerable vehicle axle and configured to provide steering functionality,
a braking system configured to provide a braking functionality, and
an electrical and/or electronic brake function unit,
wherein the brake function unit has at least one brake control function and which is configured to at least partially restrict the braking functionality during a steering operation in which a vehicle speed of the vehicle is below a limit speed, and
wherein the brake function unit has at least one activation function which is configured to activate the brake control function only when a wheel steering angle limit is exceeded.

2. The vehicle according to claim 1, wherein the wheel steering angle limit is at least 40°.

3. The vehicle according to claim 1, wherein the brake function unit comprises at least one deactivation function which is configured to deactivate the brake control function upon falling below the wheel steering angle limit and/or to cancel a restriction of the braking functionality.

4. The vehicle according to claim 1, wherein the braking system comprises a plurality of individually actuatable wheel brakes and the brake function unit is configured to restrict braking functionality during the steering operation such that braking torque acting on the steerable vehicle axle is reduced, and wherein at least one braking torque on an inner vehicle wheel is reduced.

5. The vehicle according to claim 1, further comprising at least one further vehicle axle, wherein the braking system is configured to impact the further vehicle axle only during the steering operation for braking of the vehicle.

6. The vehicle according to claim 1, further comprising vehicle sensors configured to detect a vehicle incline and/or a roadway incline, wherein the brake function unit is configured to consider vehicle incline and/or roadway incline when restricting braking functionality, and the braking torques on the individual vehicle wheels vary depending on the vehicle incline and/or the roadway incline.

7. The vehicle according to claim 1, further comprising an environmental sensor system configured to sense a vehicle environment, wherein the brake function unit is configured to account for environmental objects in the vehicle environment when restricting braking functionality, and to vary the braking torques on the individual vehicle wheels as a function of the environmental objects.

8. A method for operating a vehicle according to claim 1, wherein the vehicle comprises at least one steerable vehicle axle with an increased wheel steering angle setting range with a maximum wheel steering angle of more than 40°, a steering system that is operatively connected to the steerable vehicle axle for providing steering functionality and a braking system for providing a braking functionality, wherein the braking functionality is at least partially restricted during a steering operation in which a vehicle speed of the vehicle is below a limit speed by way of a brake control function and wherein the brake control function is only activated when a wheel steering angle limit is exceeded.

9. The vehicle according to claim 1, wherein the vehicle is a motor vehicle.

10. The motor vehicle according to claim 1, wherein the at least one steerable vehicle axle is configured to provide the increased wheel steering angle setting range with a maximum wheel steering angle of more than 40°.

11. The vehicle according to claim 6, wherein the braking torques on the individual vehicle wheels vary depending on the vehicle incline and/or the roadway incline so that each vehicle wheel brakes exactly as much as needed so that the vehicle does not move.
